(19) United States
(12) Patent Application Publication
(10) Pub. No.: US 2015/0186133 A1
(43) Pub. Date: Jul. 2, 2015

(54) SYSTEMS AND METHODS FOR ENTERPRISE APPLICATION PORTFOLIO MANAGEMENT

(71) Applicants: Aravind Ajad Yarra, Bangalore (IN); Munish Kumar Gupta, Bangalore (IN)

(72) Inventors: Aravind Ajad Yarra, Bangalore (IN); Munish Kumar Gupta, Bangalore (IN)

(73) Assignee: WIPRO LIMITED, Bangalore (IN)

(21) Appl. No.: 14/185,290

(22) Filed: Feb. 20, 2014

(30) Foreign Application Priority Data
Jan. 1, 2014 (IN) 1/CHE/2014

(51) Int. Cl. G06F 9/44

(52) U.S. Cl. CPC G06F 8/71

(57) ABSTRACT

This disclosure relates generally to information technology management, and more particularly to systems and methods for enterprise application portfolio management. In one embodiment, an application portfolio management system is disclosed, comprising: a hardware processor; and a memory storing processor-executable instructions for: receiving application usage data associated with software applications utilized by a plurality of users; obtaining computer program instructions for processing the application usage data; processing the application usage data according to the computer program instructions, to generate a recommendation for one or more maintenance operations associated with one or more of the applications; and providing the generated recommendation.

### PRIORITY CLAIM

This U.S. patent application claims priority under 35 U.S.C. §119 to Indian Patent Application No. 1/CHE/2014, filed Jan. 1, 2014, and entitled “SYSTEMS AND METHODS FOR ENTERPRISE APPLICATION PORTFOLIO MANAGEMENT.” The aforementioned application is incorporated herein by reference in its entirety.

### TECHNICAL FIELD

This disclosure relates generally to information technology management, and more particularly to systems and methods for enterprise application portfolio management.

### BACKGROUND

Enterprise application portfolio management (APM) involves managing the lifecycle of software applications across the enterprise. APM includes processes that help in taking decisions to manage large application portfolios. These decisions include, for example: when to invest in new applications; when to retire older applications; and when to enhancing the application portfolio.

APM typically involves calculating various metrics in connection with the applications using application-related data. Gathering such data often involves manual activities such as talking to the various users and owners of the applications. The data collated from the users and owners is subjective, rather than objective. Further, such processes are complex, error-prone, and labor-intensive. Also, the collected data often becomes outdated because the applications continuously evolve. The frequency of data collection often does not match the pace of change.

### SUMMARY

In one embodiment, an application portfolio management method is disclosed, comprising: receiving application usage data associated with software applications utilized by a plurality of users; obtaining computer program instructions for processing the application usage data; processing, using one or more hardware processors, the application usage data according to the computer program instructions, to generate a recommendation for one or more maintenance operations associated with one or more of the applications; and providing the generated recommendation.

In one embodiment, an application portfolio management system is disclosed, comprising: a hardware processor; and a memory storing processor-executable instructions for: receiving application usage data associated with software applications utilized by a plurality of users; obtaining computer program instructions for processing the application usage data; processing the application usage data according to the computer program instructions, to generate a recommendation for one or more maintenance operations associated with one or more of the applications; and providing the generated recommendation.

In one embodiment, a non-transitory computer-readable medium is disclosed, storing application portfolio management instructions, the instructions comprising instructions for: receiving application usage data associated with software applications utilized by a plurality of users; obtaining computer program instructions for processing the application usage data; processing the application usage data according to the computer program instructions, to generate a recommendation for one or more maintenance operations associated with one or more of the applications; and providing the generated recommendation.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates exemplary components of an enterprise application portfolio management system according to some embodiments.

FIGS. 2A, 2B, 2C, 2D, 2E, 2F, and 2G illustrate graphical user interfaces of an enterprise application store according to some embodiments.

FIG. 3 is a flow diagram illustrating a first exemplary application metadata generation procedure in accordance with some embodiments.

FIG. 4 is a flow diagram illustrating a second exemplary application metadata generation procedure in accordance with some embodiments.

FIGS. 5A and 5B are flow diagrams illustrating an exemplary rule-based metadata selection and transmission procedure in accordance with some embodiments.

FIGS. 6A and 6B are flow diagrams illustrating an exemplary rule-based enterprise application portfolio management procedure in accordance with some embodiments.

FIG. 7 is a block diagram of an exemplary computer system for implementing embodiments consistent with the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

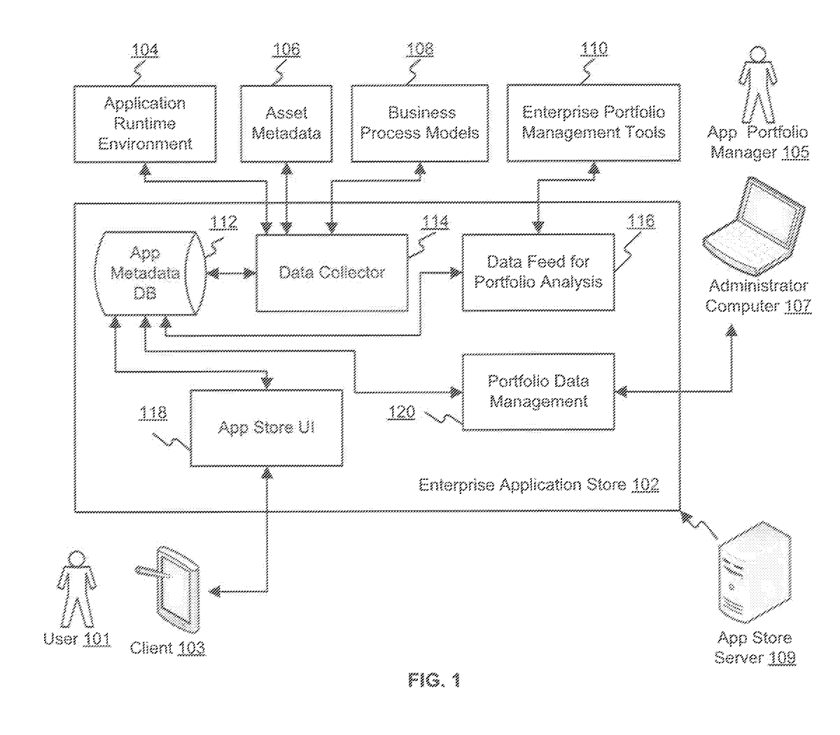

FIG. 1 illustrates exemplary components of an enterprise application portfolio management system according to some embodiments. In some embodiments, a user 101 may employ client 103 to execute software applications (“apps”). The apps may be downloaded and installed on to client 103 using an enterprise application store 102 (“app store”). For example, an app store server 109 may provide an app store UI 118 to client 103. Using the app store UI, user 101 may select one or more apps, which client 103 may download and install. In some embodiments, as user 101 utilizes the apps on client 103, client 103 may provide metadata to app store server 109. For example, the metadata may include information on app usage by user 101, feedback that user 101 may provide on one or more apps, app performance as executed on client 103, etc. Such metadata may be stored by app store server 109 at app metadata database 112. Data collector 114 may obtain metadata from a number of application portfolio management-related tasks (e.g., application runtime environment 104, asset metadata 106, business process models 108, enterprise portfolio management tools 110, etc.), and may provide the data to the app metadata database. In some embodiments, Data collector 114 may also obtain metadata from the app metadata database, and may provide the data to accomplish a number of application portfolio management-related tasks. For example, such metadata may be used to modify an application runtime environment (see 104), generate metadata reports related to a specified software application asset (see 106), optimize business process models (see 108), and facilitate enterprise portfolio management tools (see 110). In some embodiments, a portfolio data management software component may access the aggregated metadata stored in app metadata database 112, and provide the data (e.g., in the forms of statistical reports, as a RSS feed, etc.) to an administrator computer 107, which may be viewed by an application portfolio manager 105.

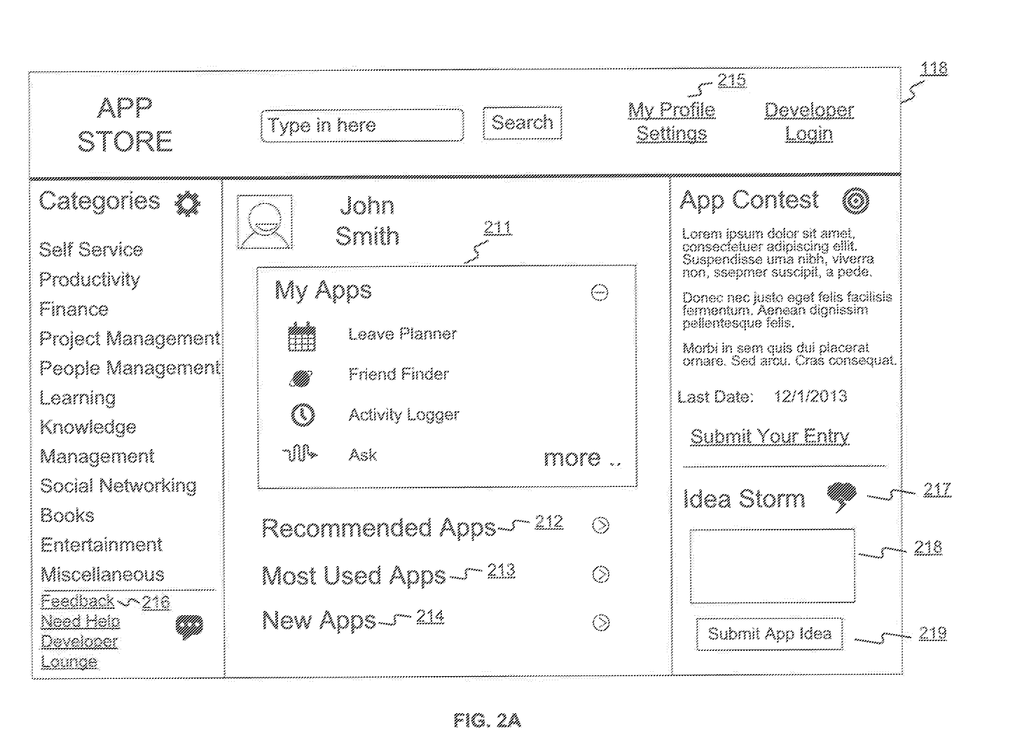

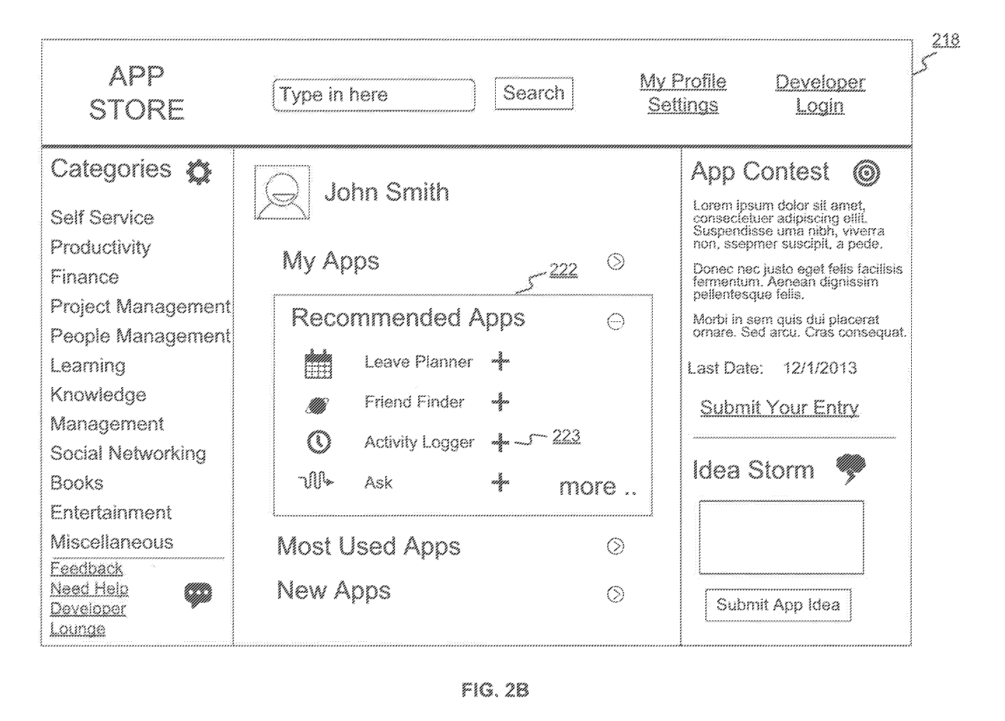

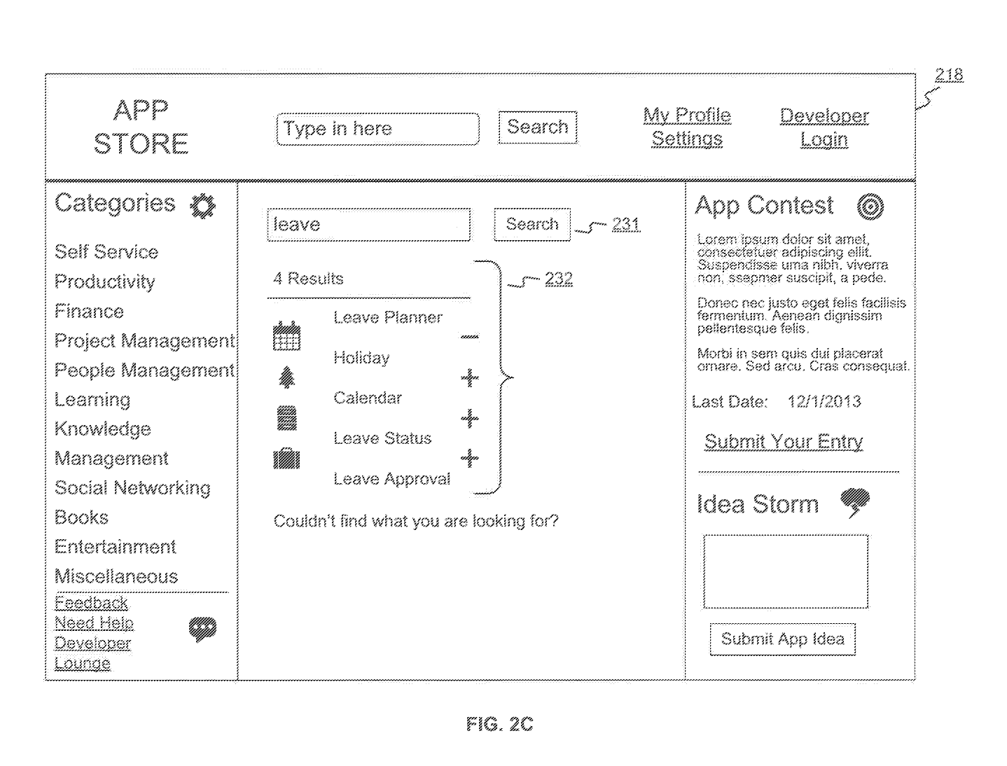

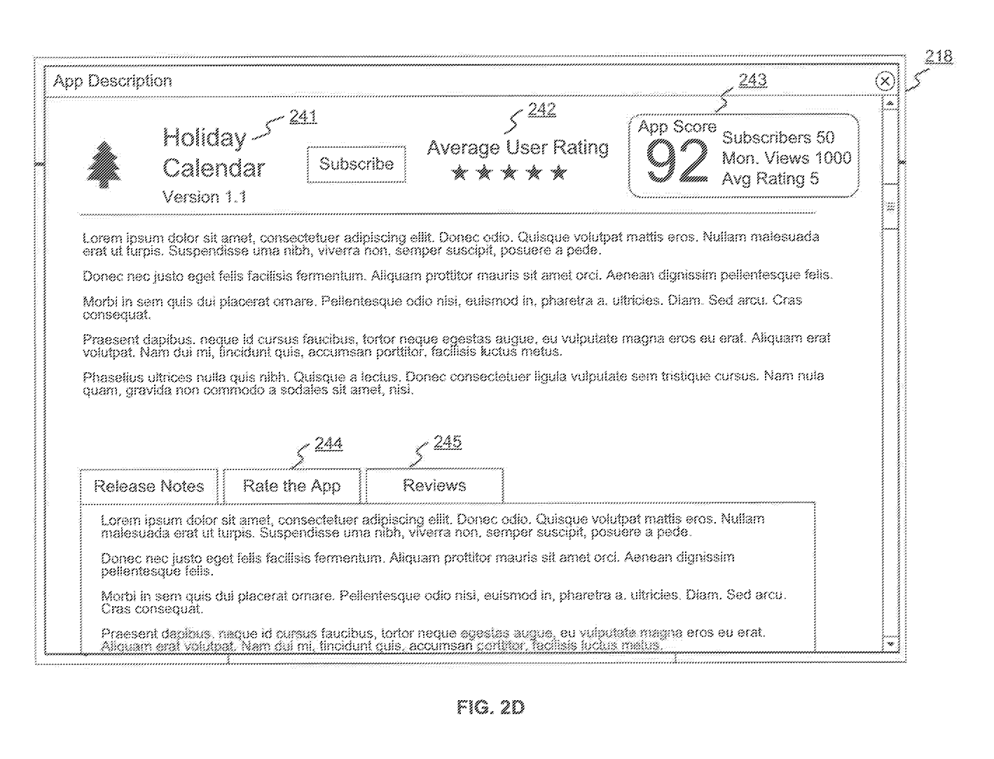

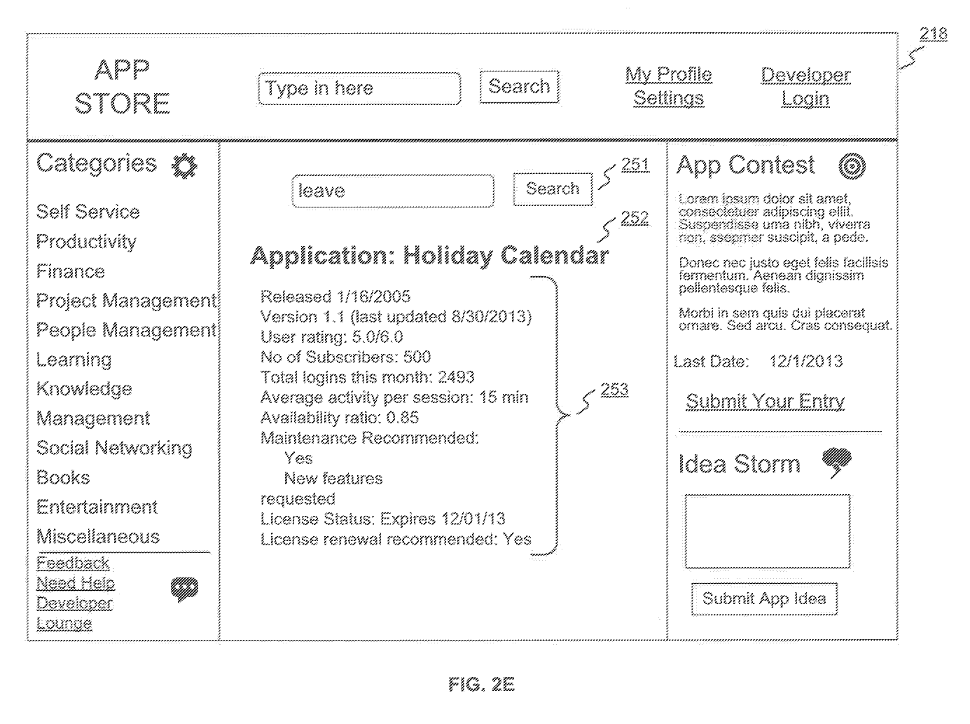

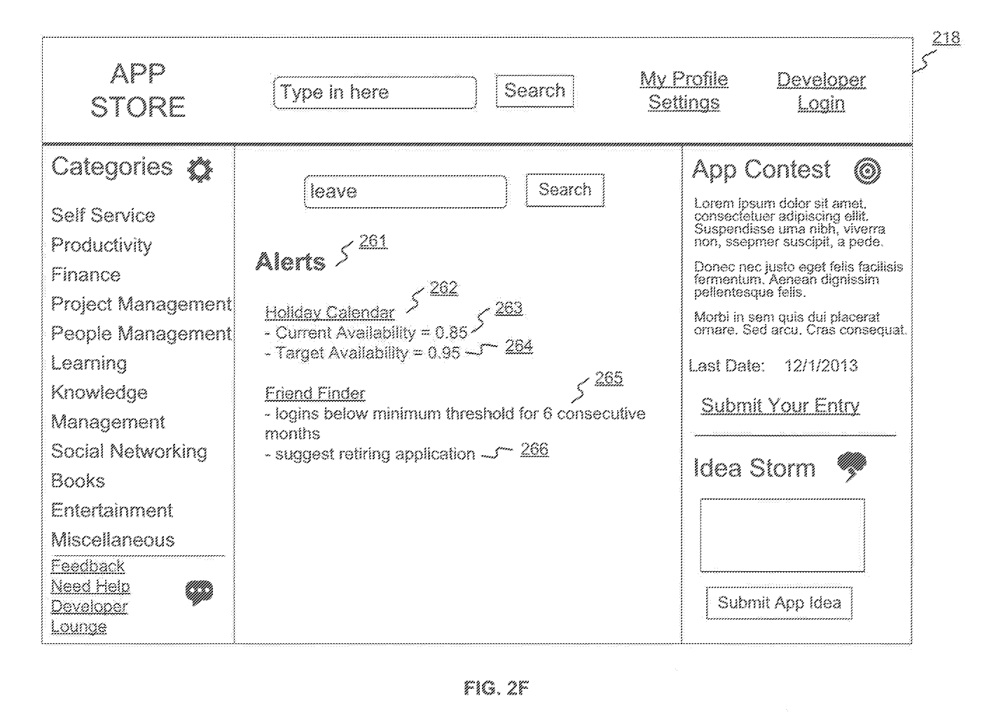

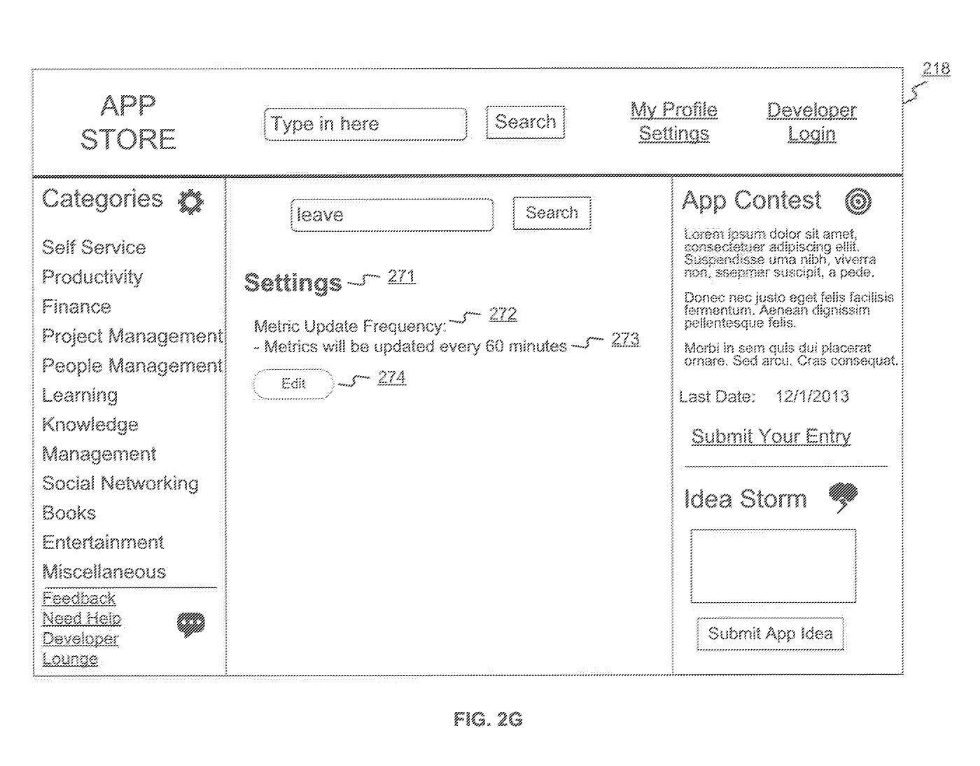

FIGS. 2A, 2B, 2C, 2D, 2E, 2F, and 2G illustrate graphical user interfaces of an enterprise application store according to some embodiments. As shown in FIG. 2A, in some embodiments, client 103 may display a graphical user interface 118 to user 101, or administrator computer 107 may display it for app portfolio manager 105. Graphical user interface 118 may depict user interface elements with which the user can interact using an input device, such as a keyboard, mouse, trackpad, etc. For example, the user may be able to select software applications (“apps”) to download from app store server 109 via graphical user interface 118. Graphical user interface 118 may provide the user with information on apps that are presently installed on the computer (see 211). Such information may be stored at app store server 109, and may be provided to the user via graphical user interface 118. Graphical user interface 118 may also indicate other apps that app store server 109 determines should be recommended the user to download and install on the computer (see 212). In some embodiments, app store server 109 may have stored data on usage by a user of apps installed on a computer. Graphical user interface 118 may provide user interface elements providing information on app usage (see 213). Graphical user interface 118 may also indicate apps that have recently become available for download and installation on to the computer (see 214). The user can configure any aspects of graphical user interface 118 by modifying the user's profile settings (see 215). For example, the computer can provide required data (e.g., metadata) that, along with data from other users, determine which apps are recommended via graphical user interface 118, e.g., in accordance with settings configured by app portfolio manager 105 via administrator computer 107). The computer may provide feedback (see 216) regarding any app, or regarding any aspect related to graphical user interface 118. Further, the user can submit ideas regarding any app of any aspect related to graphical user interface 118 (see 217-219). For example, the user can submit ideas regarding which apps should be purchased (or have its associated license agreement or modified), retired, modified, etc.

As shown in FIG. 2B, graphical user interface 118 may provide a list of recommended apps (see 222). The apps may be recommended by app store server 109 based on the user's prior usage of apps installed on the computer. In some embodiments, the computer may utilize an app, such as an activity logger (see 223), to log activity of one or more users. As shown in FIG. 2C, the user can search for apps to install on to the computer (see 231). Based on the search graphical user interface 118 may provide search results for apps that the user can then install on client 103 (see 232).

As shown in FIG. 2D, user 101 can select an app (such as 241) to download and install on client 103. The graphical user interface 118 may provide a screen with detailed information on the selected app. For example, the screen may include interface elements providing an average user rating (242), an app score and app usage statistics (see 243), etc. Also, the user can rate the app (see 244), and write or provide reviews of the app (see 245). App store server 109 may use the ratings and review of user 101 to generate statistics and recommendations to provide via graphical user interface 118.

As shown in FIG. 2E, 2E-G are screens for administrator-update graphical user interface 118 can provide a detailed view of statistics of a selected app. For example, the user can search for an app (see 251). The graphical user interface 118 may provide detailed statistics (see 253) for the app (see 252). For example, the details may include a date of software release, a version number, an average user rating, a total number of subscribers, a total number of logins over a period of time, average activity amounts, an availability ratio (e.g., for apps with a limit on a number of concurrent users), maintenance recommendations, licensing status, recommendations on renewal of licensing (based on data collected), etc. Example recommendations include, without limitation: a recommendation to terminate a software license, a recommendation to renew a software license, a recommendation to upgrade software to a newer version, a recommendation to decommission an application, or a recommendation to upgrade hardware associated with an application. It is to be understood that any recommendation regarding modification of a software or hardware component is contemplated herein.

As shown in FIG. 2F, graphical user interface 118 may provide alerts to the user. For example, with regard to app availability ratio, the graphical user interface 118 may provide a detailed view of app availability (see 263) for the user during a holiday period (see 262). The user may set a target availability ratio (see 264) at which to receive alerts (see 261), so that the user may be notified by the app is available for use. The user may elect to receive additional alerts regarding app usage. For example, a user may be notified if the user has used an app at a level below a minimum threshold (see 265). Graphical user interface 118 may provide recommendations along with such alerts, e.g., to retire an application, or renew its license (see 266). Example recommendations include, without limitation: a recommendation to terminate a software license, a recommendation to renew a software license, a recommendation to upgrade software to a newer version, a recommendation to decommission an application, or a recommendation to upgrade hardware associated with an application. It is to be understood that any recommendation regarding modification of a software or hardware component is contemplated herein. As shown in FIG. 2G, the user may provide settings (see 271), such as a frequency for updating metrics regarding an app (272-273). Graphical user interface 118 may provide a user interface element (see 274) using which the user can edit these settings.

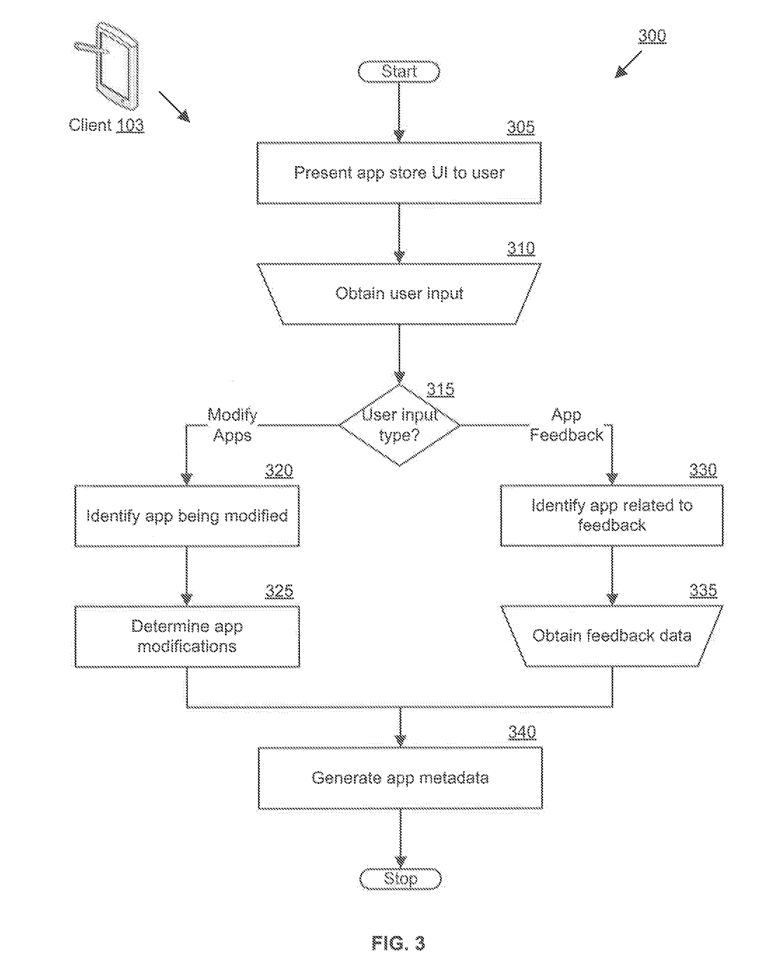

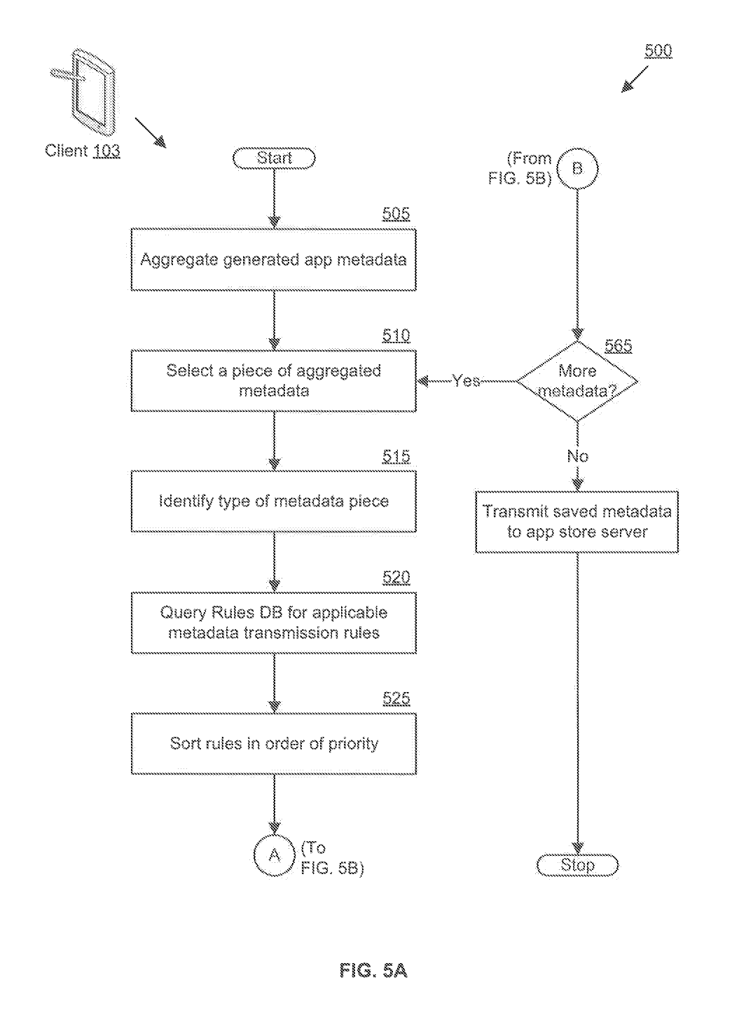

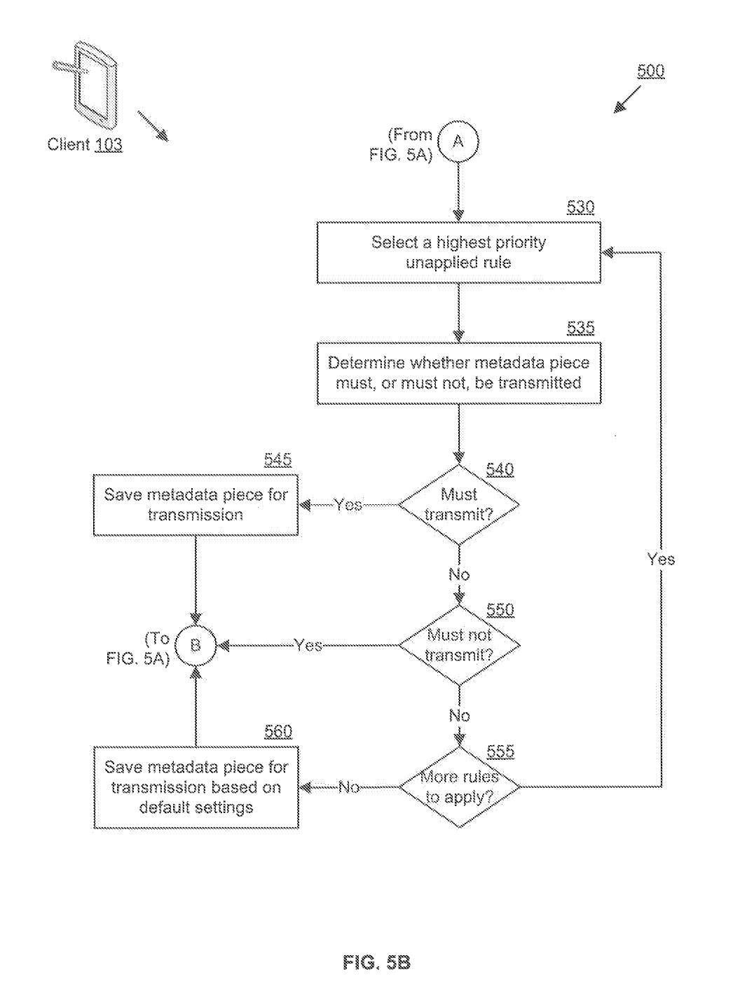

FIG. 3 is a flow diagram illustrating a first exemplary application metadata generation procedure 300 in accordance with some embodiments. In some embodiments, at step 305, client 103 or administrator computer 107 may present an app store user interface (“UI”) to user 101 or app portfolio manager 105, respectively. For example, the user interface screens of FIGS. 2A-G may be presented. At step 310, the computer may obtain user input from the user in response to providing the UI for that user or another user. At step 315, the computer may determine what type of input the user has provided into the UI. For example, if the user provided an input to modify an app (e.g., install, uninstall, add/remove features, log in, etc.), the computer may identify the app that is being modified at step 320. At step 325, the computer may determine the app modifications. If the user provided an input to provide feedback on an app, at step 330, the computer may identify the app regarding which the user provided feedback, the computer may, at step 335, obtain the feedback data provided by the user. Using the identified app modifications and/or feedback data, at step 340, the computer may generate app metadata for transmission to app store server 109. For example, the computer may use procedure 500 discussed below with reference to FIG. 5, to identify the metadata that should be transmitted, and transmit the identified metadata.

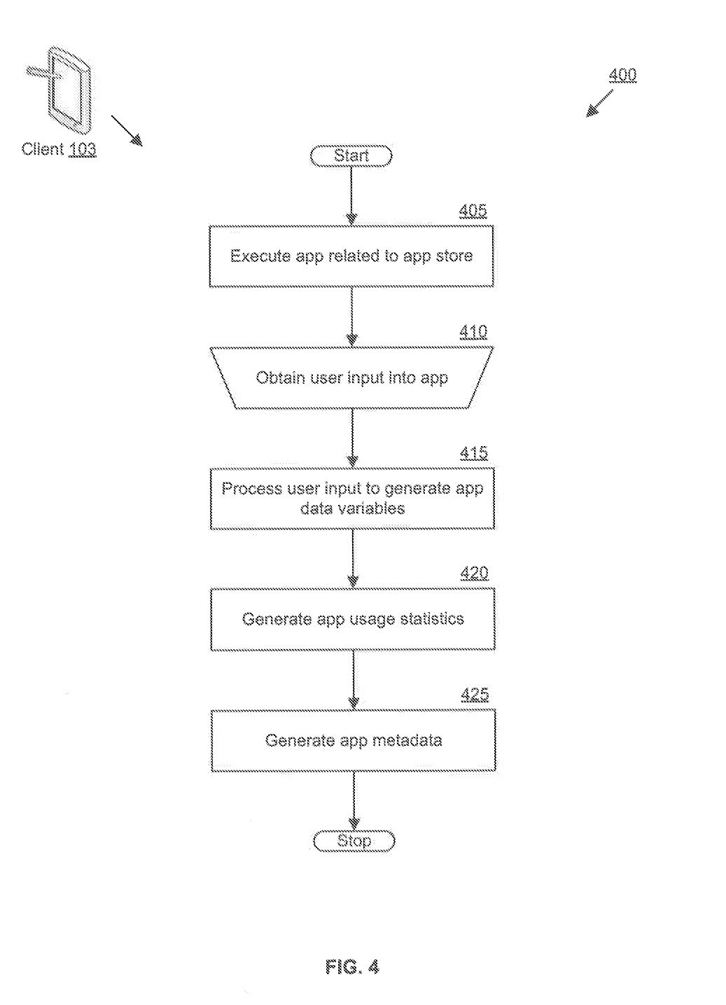

FIG. 4 is a flow diagram illustrating a second exemplary application metadata generation procedure 400 in accordance with some embodiments. In some embodiments, at step 405, client 103 may execute an app that is downloaded and installed using the app store. At step 410, client 103 may obtain user input into the app. At step 420, client 103 may process the user input to generate app variables stored in memory on client 103. Examples of such variables may reflect parameters including, without limitation, amount of user input, duration of user interaction with the app, amount of app-related computation, etc. Using such variables, at step 425, client 103 may generate app metadata for transmission to app store server 109. For example, client 103 may use procedure 500 discussed below with reference to FIG. 5, to identify the metadata that should be transmitted, and transmit the identified metadata.

FIGS. 5A and 5B are flow diagrams illustrating an exemplary rule-based metadata selection and transmission procedure 500 in accordance with some embodiments. As shown in FIG. 5A, at step 505, app store server 109 or client 103 may aggregate metadata generated previously, e.g., according to procedures 300 and 400 discussed above with reference to FIGS. 3-4. At step 510, the computer may select a piece of the aggregated metadata, to determine whether it should be transmitted to app store server 109. At step 515, the computer may identify a type for the metadata piece (e.g., user feedback, usage statistics, etc.), and at step 520, the computer may query a database for applicable rules to determine whether the metadata should, or should not, be transmitted. At step 525, the computer may sort the applicable rules in order of priority, e.g., so that the rules of higher priority are applied before rules of lower priority.

As shown in FIG. 5B, at step 530, the computer may select an unapplied rule of highest priority, and apply the selected rule to the selected piece of metadata. An example rule, written substantially in the form of XML-structured data, is provided below:

<RULE>

<IF>metadata_type=APP_USAGE</if><AND>
<IF>app_name=”security_scanner”</IF>
<THEN>instruction=TRANSMIT_ANONYMOUSLY”</THEN>
<ELSE>instruction=DEFER</ELSE>

</RULE>

The rules can be complicated, including multiple, nested conditions, and incorporate branched decision-making. Examples rules may dictate what level of information from the application logs (from 104) should be collected. For example, a rule may specify that Data Collector 114 should only collect Errors and Response time, but should ignore CPU & Memory usage. As another example, the rules may determine what attributes of Asset Data should be collected. For example, the rules may specify that Application Name, Server details of where it is hosted. Business Process it maps to, and Importance/Criticality of the application should be collected, but that attributes like Maintenance Time, Owner of the Application should be ignored (e.g., to maintain privacy). As another example, the rules may determine whether Ratings & Feedback are reported with or without user attribution (e.g., anonymous collection). In some cases, the rules may determine whether data should be selectively collected by app or by category of apps (e.g., games, business productivity, etc.). It is to be understood that the rules discussed above are exemplary only and do not limit the disclosure.

Using the rule, at step 535, the computer may determine whether metadata piece must, or must not, be transmitted for collection in app metadata database 112. At step 540, if the computer determines that the metadata piece must be transmitted for storage, the computer may, at step 545, save the metadata piece for transmission. At step 550, if the computer determines that the metadata piece must not be transmitted for storage, client 103 may terminate processing for the currently selected metadata piece, and send processing to step 565 (FIG. 5A). If the rule is not dispositive (e.g., it dictate neither that the metadata piece must be transmitted, nor that it must not), then the computer may determine, at step 555, whether additional rules remain to be applied. If so, the computer may return processing to step 530. If not, the computer may save the metadata piece for transmission (or not), depending on default settings of the computer. When processing for a metadata piece is complete, the computer may return control of processing to step 565, where the computer may determine whether additional metadata pieces are available to be processed. The computer may repeat the above procedure for each remaining metadata piece.

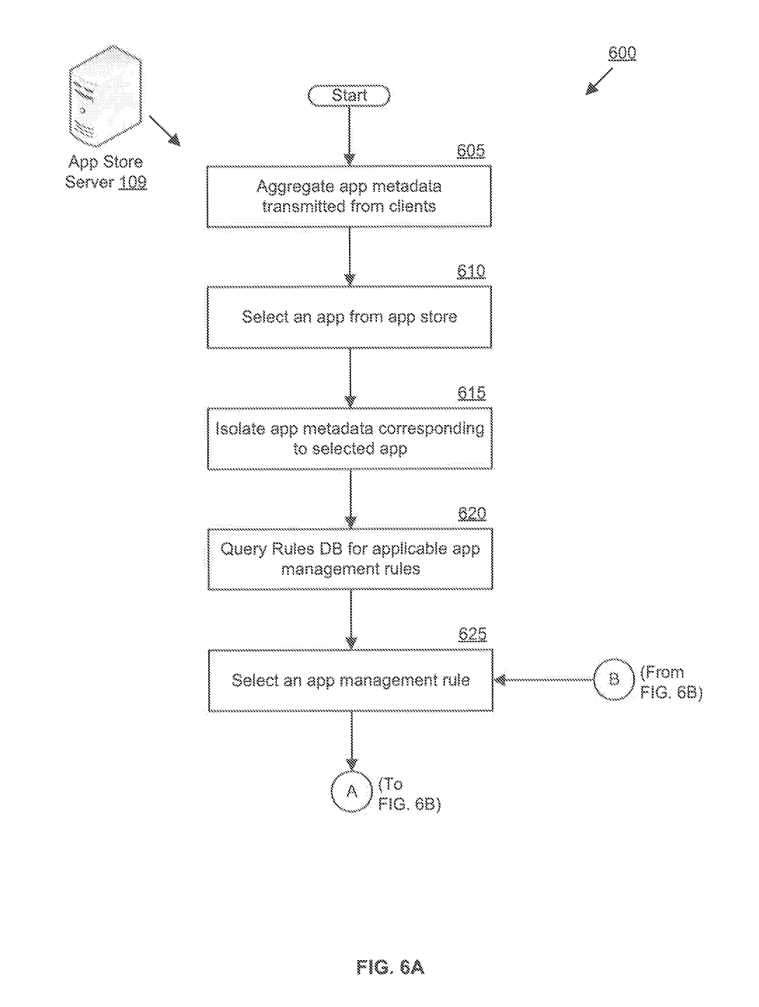

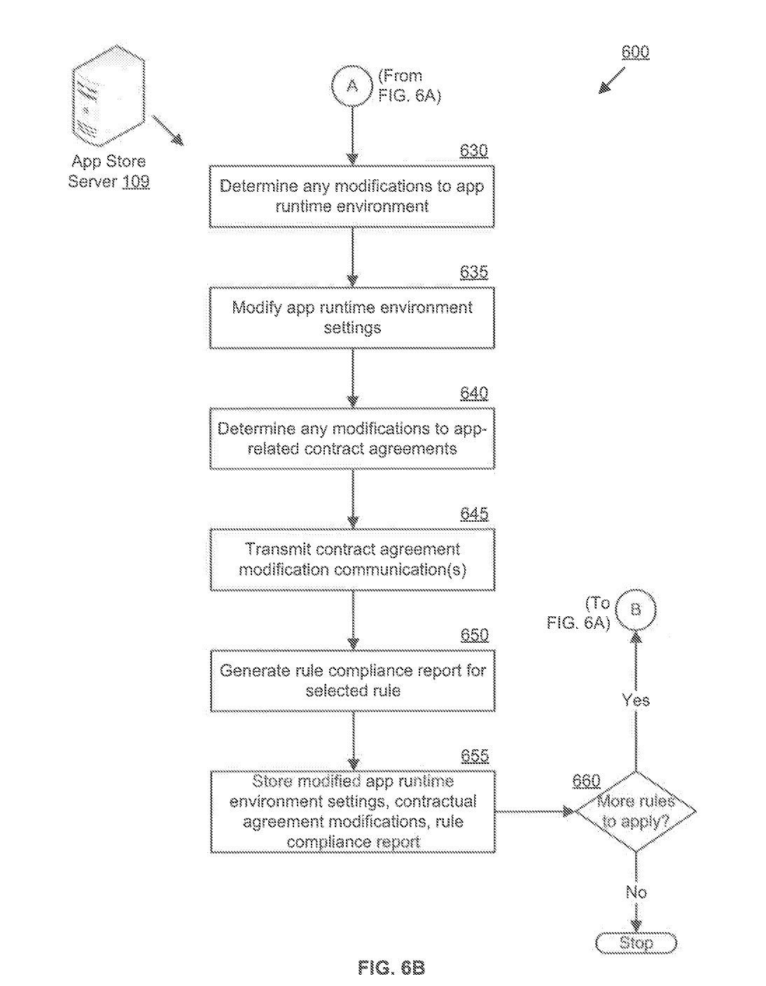

FIGS. 6A and 6B are flow diagrams illustrating an exemplary rule-based enterprise application portfolio management procedure 600 in accordance with some embodiments. As shown in FIG. 6A, at step 605, app store server 109 may aggregate app metadata transmitted from clients such as client 103. At step 610, app store server 109 may select an app included within the app store environment, and at step 615, app store server 109 may isolate app metadata corresponding to the selected app. At step 620, app store server 109 may query a database for applicable app management rules, using which the app store server 109 may determine whether any app management actions should be taken with respect to the selected app. At step 625, app store server 109 may select an app management rule.

As shown in FIG. 6B, at step 630, app store server 109 may determine any modifications to the app runtime environment using the selected app management rule. If any modifications to the app runtime environment are to be made based on the selected app management rule, at step 635, app store server 109 may modify the app runtime environment accordingly. At step 640, app store server 109 may determine any modifications to app-related contract agreements (such as purchase agreements, license agreements, number of license seats, etc.) based on the selected app management rule. For example, the app store server 109 may determine one or more recommendations, such as, without limitation: a recommendation to terminate a software license, a recommendation to renew a software license, a recommendation to upgrade software to a newer version, a recommendation to decommission an application, or a recommendation to upgrade hardware associated with an application. It is to be understood that any recommendation regarding modification of a software or hardware component is contemplated herein. If any modification to the app-related contract agreements are to be made, at step 645, app store server 109 may transmit automatically the appropriate communications to provide notification of contract agreement modification. For example, app store server 109 may transmit such notifications to a server of a software developer, a software company, an app portfolio management computer (e.g., operated by app portfolio manager 105, etc.). At step 650, app store server 109 may generate a rule compliance report, which may include a log of the processing of the rule, the results generated fro rule processing, a listing of resulting actions performed, a listing of follow-up actions to be performed, etc. At step 655, app store server 109 may store the modified app runtime environment settings, the contractual agreement modifications, the rule compliance report, etc. If any additional rules need to be applied (see step 660), app store server 109 may perform a procedure similar to that described above for the remaining rules.

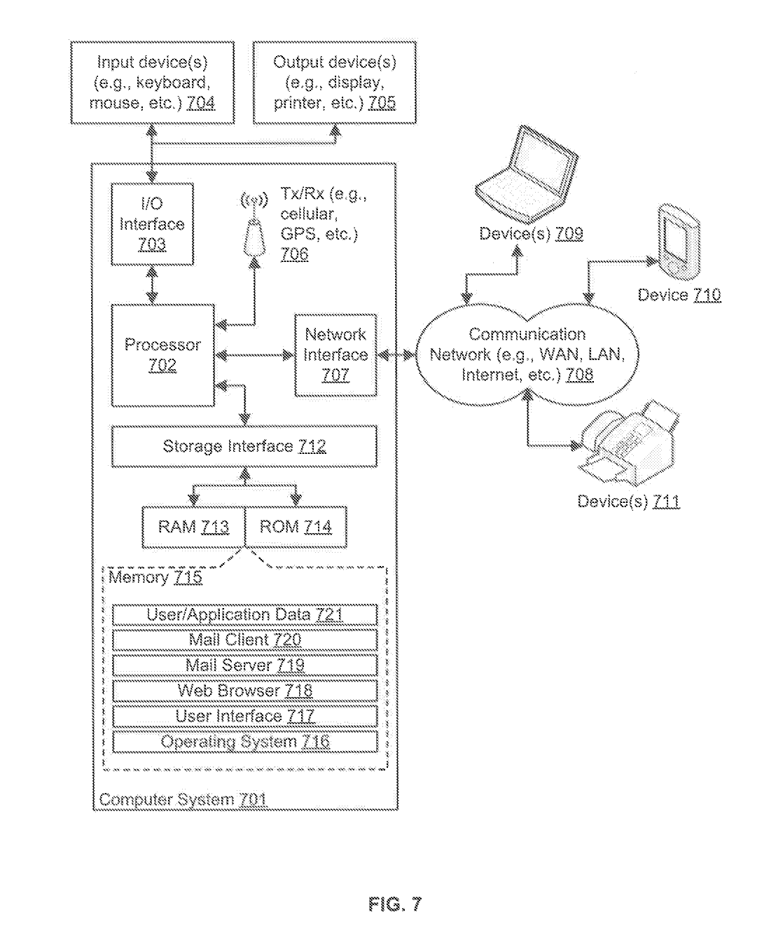

FIG. 7 is a block diagram of an exemplary computer system for implementing embodiments consistent with the present disclosure. Variations of computer system 701 may be used for implementing client 103, administrator computer 107, and app store server 109. Computer system 701 may comprise a central processing unit (“CPU” or “processor”) 702. Processor 702 may comprise at least one data processor for executing program components for executing user- or system-generated requests. A user may include a person, a person using a device such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC. Intel's Core, Itanium, Xeon, Celeron or other line of processors, etc. The processor 702 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 702 may be disposed in communication with one or more input/output (I/O) devices via I/O interface 703. The I/O interface 703 may employ communication protocols/methods such as, without limitation, audio, analog, digital, monoaural. RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.11 a/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 703, the computer system 701 may communicate with one or more I/O devices. For example, the input device 704 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 705 may be a printer, fax machine, video display (e.g., cathode ray tube (CRT), liquid crystal display (LCD), light-emitting diode (LED), plasma, or the like), audio speaker, etc. In some embodiments, a transceiver 706 may be disposed in connection with the processor 702. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 702 may be disposed in communication with a communication network 708 via a network interface 707. The network interface 707 may communicate with the communication network 708. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 708 may include, without limitation, a direct interconnection, local area network (LAN), wide area network (WAN), wireless network (e.g., using Wireless Application Protocol), the Internet, etc. Using the network interface 707 and the communication network 708, the computer system 701 may communicate with devices 709, 710, and 711. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 701 may itself embody one or more of these devices.

In some embodiments, the processor 702 may be disposed in communication with one or more memory devices (e.g., RAM 713, ROM 714, etc.) via a storage interface 712. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 716, user interface application 717, web browser 718, mail server 719, mail client 720, user/application data 721 (e.g., any data variables or data records discussed in this disclosure), etc. The operating system 716 may facilitate resource management and operation of the computer system 701. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 717 may facilitate display, execution, interaction, manipulation, or operation of program components through textual or graphical facilities. For example, user interfaces may provide computer interaction interface elements on a display system operatively connected to the computer system 701, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 701 may implement a web browser 718 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 701 may implement a mail server 719 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 701 may implement a mail client 720 stored program component. The mail client may be a mail viewing application, such as Apple Mail, Microsoft Entourage, Microsoft Outlook, Mozilla Thunderbird, etc.

In some embodiments, computer system 701 may store user/application data 721, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of any computer or database component may be combined, consolidated, or distributed in any working combination.

The specification has described systems and methods for enterprise application portfolio management. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

1. An application portfolio management method, comprising:
receiving application usage data associated with software applications utilized by a plurality of users;
obtaining computer program instructions for processing the application usage data;
processing, using one or more hardware processors, the application usage data according to the computer program instructions, to generate a recommendation for one or more maintenance operations associated with one or more of the applications; and
providing the generated recommendation.

2. The method of claim 1, wherein the recommendation includes at least one of:
a recommendation to terminate a software license,
a recommendation to renew a software license,
a recommendation to upgrade software to a newer version,
a recommendation to retire or decommission an application, or
a recommendation to upgrade hardware associated with an application.

3. The method of claim 2, further comprising:
generating automatically a software maintenance message according to the recommendation; and
providing the software maintenance message.

4. The method of claim 1, wherein the processing application usage data includes user feedback, and wherein the computer program instructions for processing the application usage data are obtained based on parsing the user feedback.

5. The method of claim 1, further comprising:
providing access-enabling software associated with the software applications;
wherein the access-enabling software is associated with a web browser user interface.

6. The method of claim 1, wherein the application usage data comprises one or more of:
a number of subscriptions to the software applications,
a time elapsed since the development of the software applications, or
a ratio of the time the applications are available to the time the applications are unavailable.

7. The method of claim 6, further comprising:
generating an alert notifying whether the ratio of the time the applications are available to the time the applications are unavailable falls below a predetermined threshold.

8. The method of claim 1, wherein the application usage data comprises at least one of: information identifying user keyboard activity; information identifying user mouse activity; information identifying user login activity; or information reflecting user satisfaction.

9. The method of claim 1, wherein the computer program instructions define a frequency for processing the application usage data.

10. An application portfolio management system, comprising:
a hardware processor; and
a memory storing processor-executable instructions for:
receiving application usage data associated with software applications utilized by a plurality of users;
obtaining computer program instructions for processing the application usage data;
processing the application usage data according to the computer program instructions, to generate a recommendation for one or more maintenance operations associated with one or more of the applications; and
providing the generated recommendation.

11. The system of claim 10, wherein the recommendation includes at least one of:
a recommendation to terminate a software license,
a recommendation to renew a software license,
a recommendation to upgrade software to a newer version,
a recommendation to retire or decommission an application, or
a recommendation to upgrade hardware associated with an application.

12. The system of claim 11, the memory further storing instructions for:
generating automatically a software maintenance message according to the recommendation; and
providing the software maintenance message.

13. The system of claim 10, wherein the processing application usage data includes user feedback, and wherein the computer program instructions for processing the application usage data are obtained based on parsing the user feedback.

14. The system of claim 10, the memory further storing instructions for:
providing access-enabling software associated with the software applications;
wherein the access-enabling software is associated with a web browser user interface.

15. The system of claim 10, wherein the application usage data comprises one or more of:
a number of subscriptions to the software applications,
a time elapsed since the development of the software applications, or
a ratio of the time the applications are available to the time the applications are unavailable.

16. The system of claim 15, the memory further storing instructions for:
generating an alert notifying whether the ratio of the time the applications are available to the time the applications are unavailable falls below a predetermined threshold.

17. The system of claim 10, wherein the application usage data comprises at least one of: information identifying user keyboard activity; information identifying user mouse activity; information identifying user login activity; or information reflecting user satisfaction.

18. The system of claim 10, wherein the computer program instructions define a frequency for processing the application usage data.

19. A non-transitory computer-readable medium storing computer-executable application portfolio management instructions for:
receiving application usage data associated with software applications utilized by a plurality of users;
obtaining computer program instructions for processing the application usage data;
processing the application usage data according to the computer program instructions, to generate a recommendation for one or more maintenance operations associated with one or more of the applications; and
providing the generated recommendation.

20. The medium of claim 19, wherein the recommendation includes at least one of:
a recommendation to terminate a software license,
a recommendation to renew a software license,
a recommendation to upgrade software to a newer version,
a recommendation to retire or decommission an application, or
a recommendation to upgrade hardware associated with an application.

21. The medium of claim 20, further storing instructions for:
generating automatically a software maintenance message according to the recommendation; and
providing the software maintenance message.

22. The medium of claim 19, wherein the processing application usage data includes user feedback, and wherein the computer program instructions for processing the application usage data are obtained based on parsing the user feedback.

23. The medium of claim 19, further storing instructions for:
providing access-enabling software associated with the software applications;
wherein the access-enabling software is associated with a web browser user interface.

24. The medium of claim 19, wherein the application usage data comprises one or more of:
a number of subscriptions to the software applications,
a time elapsed since the development of the software applications, or
a ratio of the time the applications are available to the time the applications are unavailable.

25. The medium of claim 24, further storing instructions for:
generating an alert notifying whether the ratio of the time the applications are available to the time the applications are unavailable falls below a predetermined threshold.
